(19) United States
(12) Patent Application Publication
(10) Pub. No.: US 2011/0203749 A1
(43) Pub. Date: Aug. 25, 2011

(54) DRIVE ASSEMBLY FOR DRIVING A WINDOW SHADE AND WINDOW SHADE SYSTEM

(75) Inventors: Steven H. Klotz, Commerce Township, MI (US); Charlie Sorrell, Shelby Township, MI (US); Phil Kelly, Clio, MI (US); Tom Mack, Highland, MI (US); Elbert Willis, Southfield, MI (US)

(73) Assignee: WEBASTO AG, Stockdorf (DE)

(21) Appl. No.: 12/708,782

(22) Filed: Feb. 19, 2010

(51) Int. Cl. E06B 9/70

(52) U.S. Cl. 160/311; 160/405

(57) ABSTRACT

Embodiments of the invention relate to a drive assembly for driving a window shade of a vehicle, in particular for a rear window of a vehicle, and a window shade system comprising at least two one-piece arms, first ends of which are pivotally coupleable to a window shade, and a driving means, in particular a motor, for linearly sliding pivotally mounted second ends of said one-piece arms arranged such that said one-piece arms may push or pull a window shade across a window of a vehicle.

### BACKGROUND OF THE INVENTION

The present invention relates generally to systems and methods for driving a window shade. Embodiments of the invention relate to a drive assembly for driving a window shade of a vehicle, in particular for a rear window or backlight of a vehicle and to a window shade system comprising such a drive assembly.

In vehicles, window shades for the side or rear windows help the driver to protect himself from being dazzled by sunlight or the passenger compartment from unwanted outside views. For providing the driver with the possibility to adapt the position of a window shade on his own while driving, a variety of automatically driven window shades have been developed. In particular, window shades for a rear window of a vehicle are out of reach for all vehicle passengers and thus are predestined for an automatic drive. In the context of this application, motor driven window shades for a rear window of a vehicle are also referred to as backlight power shades.

The corresponding drives—mostly using electric motors—and window shades have to fulfill a number of requirements. Firstly, they have to provide a consistent, stable and smooth deployment of a window shade. Secondly, unnecessary noise caused by the moving parts of the drive and the window shade itself should be avoided. Thirdly, in particular with respect to a window shade for a rear window, the installation space for a drive assembly for a window shade should be minimized due to the restricted space between rear window and package tray.

Conventional automobile rear window shade systems typically utilize arms which are rotationally driven at the bottom of the window shade system and have sliding elements at a top bar of the window shade, or which have two-piece pivoting arms coupled to the top bar of the window shade.

However, due to their complexity, conventional window shade systems suffer from a number of disadvantages. For instance, the high complexity of conventional drive systems may inhibit a smooth operation or consistent deployment of a window shade or may even cause stability and reliability problems. Furthermore, the typically high number of parts of current window shade systems involves higher costs and requires considerable package space at the bottom of such window shade systems just at locations of a vehicle where space is scarce.

For these or other reasons, there is a need for the present invention.

### SUMMARY

An assembly and/or method for driving a window shade of a vehicle, in particular for a rear window of a vehicle, as well as a corresponding window shade system are provided, substantially as shown in and/or described in connection with at least one of the figures, as set forth more completely in the claims.

Further features and advantages of the present invention will become apparent from the following detailed description of the invention made with reference to the accompanying drawings.

### BRIEF DESCRIPTION OF THE DRAWINGS

The accompanying drawings are included to provide a further understanding of the present invention and are incorporated in and constitute a part of this specification. The drawings illustrate embodiments of the present invention and together with the description serve to explain the principles of the invention. Other embodiments of the present invention and many of the intended advantages of the present invention will be readily appreciated as they become better understood by reference to the following detailed description.

FIG. 1 shows an example for a current window shade system with two two-piece arms and a pivot arm linkage;

FIG. 2 shows an embodiment for a window shade system in a fully deployed position of the window shade;

FIG. 3 shows an embodiment for a window shade system in a first intermediate position of the window shade;

FIG. 4 shows an embodiment for a window shade system in a second intermediate position of the window shade;

FIG. 5 shows an embodiment for a window shade system in a third intermediate position of the window shade;

FIG. 6 shows an embodiment for a window shade system in a fourth intermediate position of the window shade;

FIG. 7 shows an embodiment for a window shade system in a fully stowed position of the window shade;

FIG. 8 shows a one-piece arm according to an embodiment for operating a window shade by a drive assembly;

FIG. 9 shows an embodiment of two one-piece arms for operating a window shade in an example arrangement with respect to a motor as part of a drive assembly for a window shade;

FIG. 10 shows an embodiment of a positive stop bumper for a window shade to prevent rattle in a stowed position of the window shade;

FIG. 11 shows an embodiment of a mounting part with a polytetrafluoroethylene coated axle bushing connecting the one-piece arms with sliding parts of a drive assembly for a window shade through a bottom pivot rivet;

FIG. 12 shows an embodiment of two one-piece arms for operating a window shade in an example arrangement with respect to a top bar of a window shade and a motor as part of a drive assembly for a window shade;

FIG. 13 is a magnified detail of FIG. 12 and shows an embodiment of a spring assembly as biasing means coupled between a first end of a one-piece arm pivotally connecting the one-piece arm and a top bar of a window shade, the spring assembly maintaining a constant opposing force on the one-piece arm to aid in a consistent deployment of the window shade;

FIG. 14 is a magnified detail of FIG. 12 and shows an embodiment of a rack and pinion drive system for linearly sliding mounting parts connected to second ends of two one-piece arms for operating a window shade;

FIG. 15 shows an embodiment of a motor mounted in-line to a track assembly for the rack and pinion drive system of FIG. 14 as part of a drive assembly for a window shade;

FIG. 16 shows an embodiment of a one-piece aluminum extruded track providing a rigid body to mount a window shade system to a vehicle package tray;

FIG. 17 shows an embodiment of a two-piece guide shoe with rubber insert for noise dampening as part of a drive assembly for a window shade;

FIG. 18 shows an embodiment of the one-piece aluminum extruded track protecting a roller blind as window shade on three sides to provide robustness to assembly handling and ergonomic friendliness due to the one-piece design without a linkage;

FIG. 19 shows a schematic side view of an embodiment of a window shade system comprising means for exerting a contact force between a top bar of the window shade and a window of a vehicle;

FIG. 20 shows a side view of an embodiment of a window shade system comprising means for exerting a contact force between a top bar of the window shade and a window of a vehicle;

FIG. 21 shows an embodiment of inner and outer isolating sleeves on a spring of a roller blind system as part of an embodiment of the window shade system;

FIG. 22 shows an exploded view of an embodiment of the window shade system;

FIG. 23 shows a rear view of an embodiment of the window shade system;

FIG. 24 shows an angled rear view of an embodiment of the window shade system with a deployed roller blind in the context of the surrounding parts in a vehicle.

### DETAILED DESCRIPTION OF THE INVENTION

In the following Detailed Description, reference is made to the accompanying drawings, which form a part hereof, and in which is shown by way of illustration specific embodiments in which the invention may be practiced. It is to be understood that other embodiments may be utilized and structural or other changes may be made without departing from the scope of the present invention. The following detailed description, therefore, is not to be taken in a limiting sense, and the scope of the present invention is defined by the appended claims.

An embodiment of the invention relates to a drive assembly for driving a window shade of a vehicle, in particular a roller blind for a rear window of a vehicle. The drive assembly comprises at least two one-piece arms, first ends of which are pivotally coupleable to a window shade, and a driving means, in particular a motor, for linearly sliding pivotally mounted second ends of said one-piece arms. The at least two one-piece arms and the driving means are arranged with respect to a window shade such that said one-piece arms may push or pull a window shade across a window of a vehicle.

In an embodiment, the at least two one-piece arms are tapered and/or reinforced to mitigate a distinct natural frequency of said one-piece arms and possibly resulting squeak and rattle issues.

According to a further embodiment of the drive assembly, the pivotal mounting of the second ends of said one-piece arms comprises a polytetrafluoroethylene coated bushing for receiving a pivot rivet.

In an embodiment of the drive assembly, biasing means are coupleable between the first ends of said one-piece arms and a window shade to maintain a constant opposing force on each of said one-piece arms and enable a consistent deployment of a window shade.

According to a further embodiment of the drive assembly, the driving means is mounted to a one-piece aluminum extruded track mountable to a vehicle package tray.

Another embodiment of the invention relates to a window shade system for a vehicle, in particular for a rear window of a vehicle. The window shade system comprises a drive assembly according to any of the above embodiments and a window shade, in particular a roller blind.

An embodiment of the window shade system comprises means for exerting a contact force between a top bar of said window shade and a window of a vehicle.

In a further embodiment of the window shade system, the window shade is mounted to the one-piece aluminum extruded track such that window shade is protected by the one-piece aluminum extruded track.

According to another embodiment of the window shade system, the window shade comprises a positive stop bumper to prevent rattle in a stowed position of the window shade.

A further embodiment of the invention relates to a method for driving a window shade of a vehicle, in particular for a rear window of a vehicle. The method comprises pushing or pulling a window shade across a window of a vehicle by using at least two one-piece arms, first ends of which are pivotally coupleable to a window shade, and linearly sliding pivotally mounted second ends of said one-piece arms by a driving means, in particular a motor.

Embodiments of the invention relate to window shade systems which may provide a transparent interface to other design programs and may be capable of being scaled to subsequent platform applications with or without minor modifications.

Window shade systems according to embodiments of the invention may utilize as many common parts and methodologies from a moonroof application as possible to minimize complexity, part count, squeak and rattle and vehicle interface issues while addressing the known failure modes typical of roller products currently available.

Embodiments of the invention may achieve a smaller package at the bottom of the window shade system where the drive system is positioned, smaller and less costly parts, and smother more stable operation during deployment.

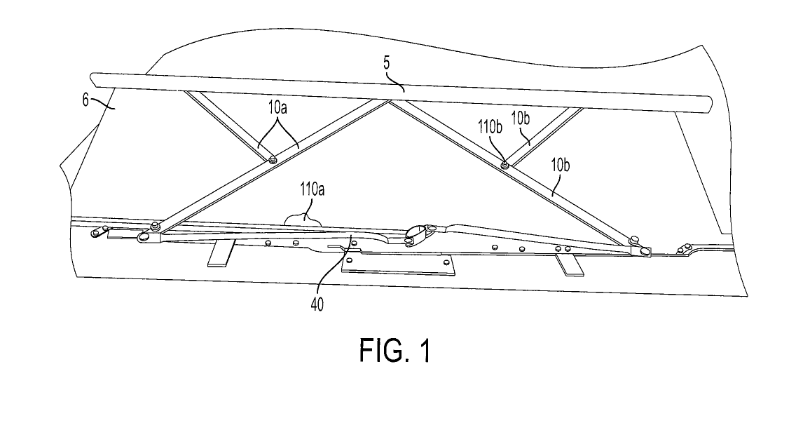

Now referring to FIG. 1, an example is shown for a current window shade system with two two-piece arms 10a, 10b connected to a top bar 5 of a roller blind 6. By operating the driving mechanism 40, the two two-piece arms 10a, 10b push or pull the roller blind 6 guided by guides across a rear window of a vehicle. The two two-piece arms 10a, 10b are linked by respective pivot arm linkages 110a, 110b. The two two-piece arms 10a, 10b and the pivot arm linkages 110a, 110b increase the complexity of the corresponding drive assembly for the roller blind 6 and may cause less smooth or unstable operation or even total failure of operation. Moreover, the high number of moved or moveable parts, in particular the two two-piece arms 10a, 10b and/or the two pivot arm linkages 110a, 110b may increase the noise level during operation or simply while driving a bumpy road by squeaking or rattling.

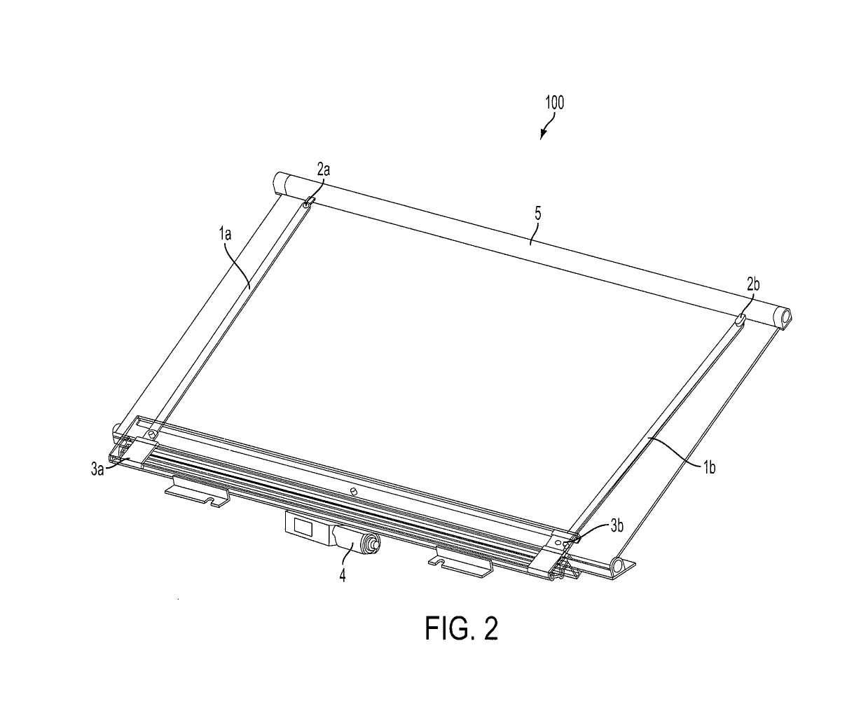

FIG. 2 shows an embodiment of the present invention comprising a window shade system 100 in a fully deployed position of the window shade. In this embodiment, a roller blind is used as window shade. The roller blind may be operated, i.e. pushed upwards or pulled downwards across the rear window of a vehicle. For this purpose, a drive assembly is provided which comprises two one-piece arms 1a, 1b. These two one-piece arms 1a, 1b eliminate a pivot rivet and joint—and thus the pivot arm linkages 110a, 110b—from each of the arms 10a, 10b in the conventional window shade system of FIG. 1.

First ends 2a, 2b of the two one-piece arms 1a, 1b are pivotally coupled to a top bar 5 of the roller blind. Moreover, the drive assembly according to the embodiment of FIG. 2 comprises a motor 4 for linearly sliding pivotally mounted second ends 3a, 3b of the one-piece arms 1a, 1b. The two one-piece arms 1a, 1b and the motor 4 are arranged with respect to the roller blind such that said the first ends 2a, 2b of the one-piece arms 1a, 1b—when the pivotally mounted second ends 3a, 3b of said one-piece arms 1a, 1b are linearly slid by a rack and pinion drive using the motor 4—push or pull the top bar 5 of the roller blind across a window of a vehicle.

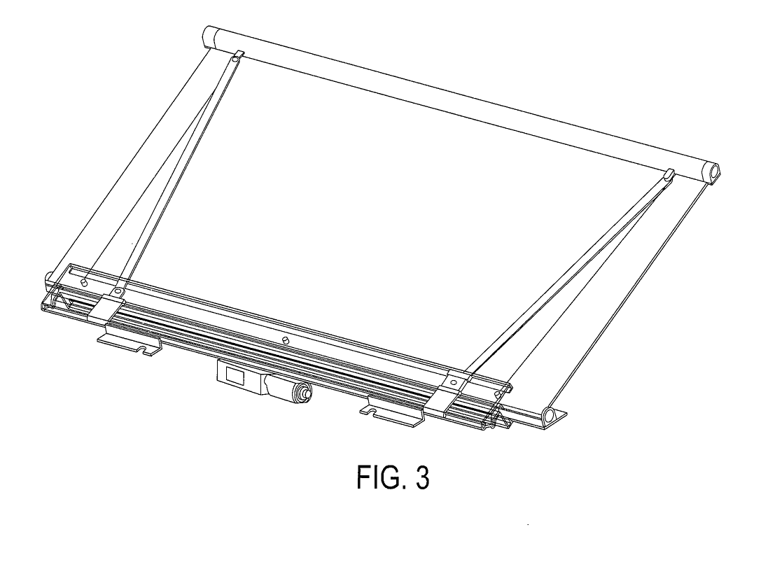

FIG. 3 shows the embodiment of the window shade system 100 according to FIG. 2 in a first intermediate position of the roller blind, i.e. the applied kinematics of the window shade system 100. In this position, the pivotally mounted second ends 3a, 3b of said one-piece arms 1a, 1b have both been linearly moved inwards towards the motor 4 by the rack and pinion drive using the motor 4. As a result of this movement, the first ends 2a, 2b of the one-piece arms 1a, 1b have pulled the top bar 5 of the roller blind a corresponding way downwards towards the motor 4. There may be guides that further guide the movement of the top bar 5 of the roller blind across the rear window such that a consistent and precisely defined deployment of the roller blind is facilitated.

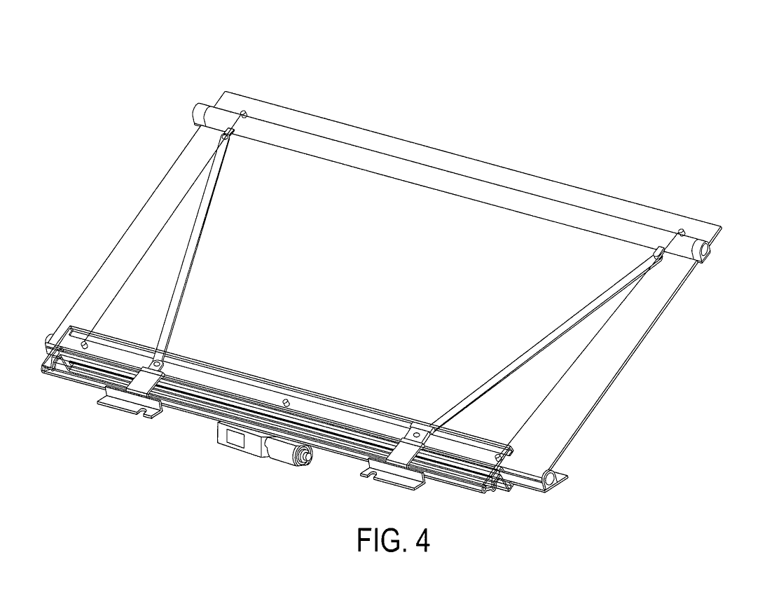

FIG. 4 shows the embodiment of the window shade system 100 according to FIG. 2 in a second intermediate position of the roller blind. In this position, the pivotally mounted second ends 3a, 3b of said one-piece arms 1a, 1b have been moved further linearly inwards towards the motor 4 by the rack and pinion drive using the motor 4. As a result of this movement, the first ends 2a, 2b of the one-piece arms 1a, 1b have pulled the top bar 5 of the roller blind a further way downwards towards the motor 4.

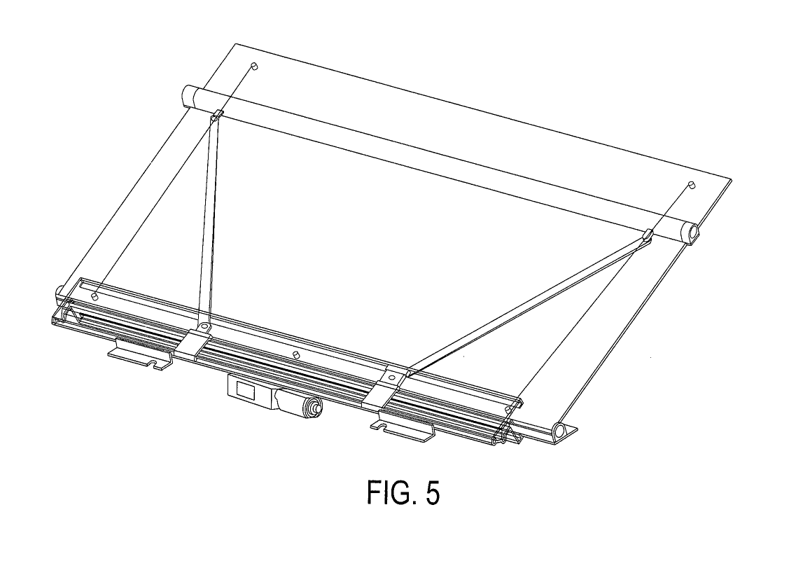

FIG. 5 shows the embodiment of the window shade system 100 according to FIG. 2 in a third intermediate position of the roller blind. In this position, the pivotally mounted second ends 3a, 3b of said one-piece arms 1a, 1b have been moved even further linearly inwards towards the motor 4 by the rack and pinion drive using the motor 4. As a result of this movement, the first ends 2a, 2b of the one-piece arms 1a, 1b have pulled the top bar 5 of the roller blind a still further way downwards towards the motor 4.

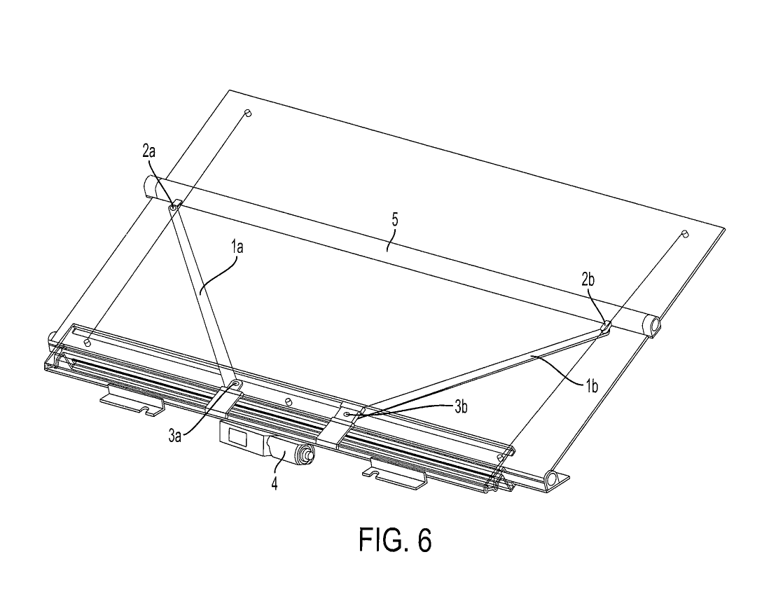

FIG. 6 shows the embodiment of the window shade system 100 according to FIG. 2 in a fourth intermediate position of the roller blind. In this position, the pivotally mounted second ends 3a, 3b of said one-piece arms 1a, 1b have been moved still further linearly inwards towards the motor 4 by the rack and pinion drive using the motor 4. As a result of this movement, the first ends 2a, 2b of the one-piece arms 1a, 1b have pulled the top bar 5 of the roller blind halfway downwards towards the motor 4.

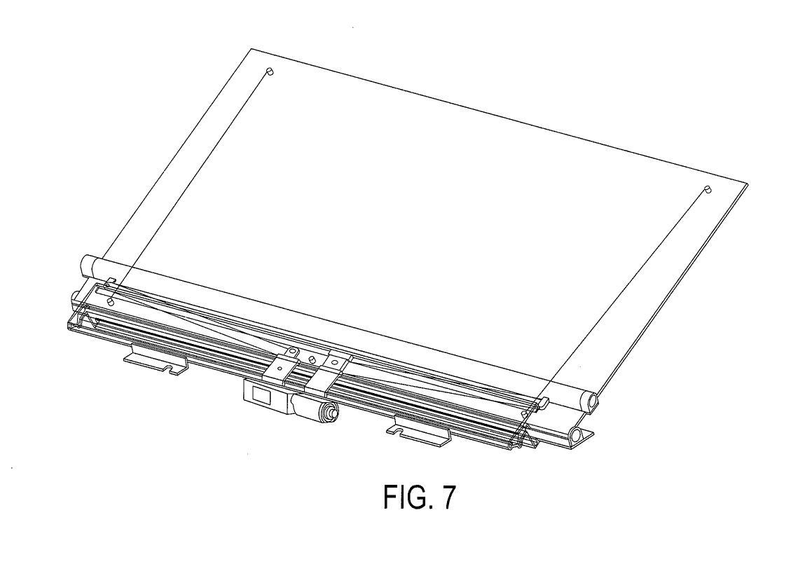

FIG. 7 shows the embodiment of the window shade system 100 according to FIG. 2 in a substantially fully stowed position of the roller blind. In this position, the pivotally mounted second ends 3a, 3b of said one-piece arms 1a, 1b have been moved linearly substantially to their most inward positions by the rack and pinion drive using the motor 4. As a result of this movement, the first ends 2a, 2b of the one-piece arms 1a, 1b have pulled the top bar 5 of the roller blind substantially to its most downward position with respect to the rear window.

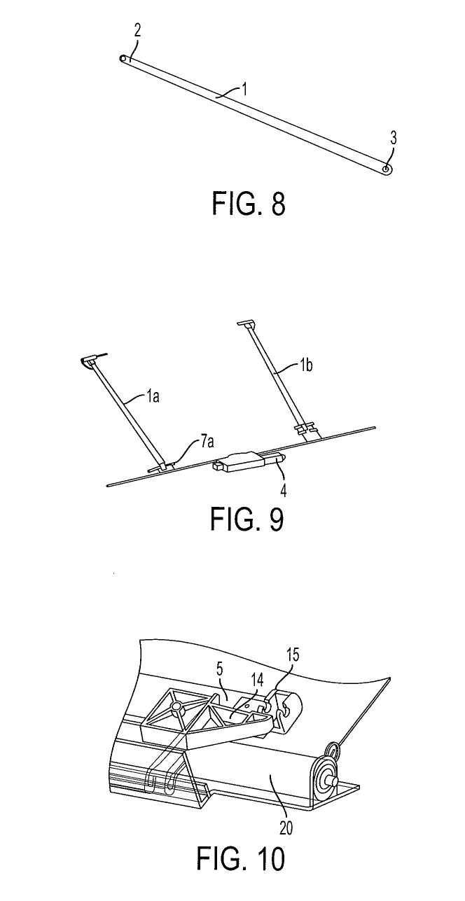

FIG. 8 shows a one-piece arm 1 according to an embodiment of the invention for operating a window shade by a drive assembly. FIG. 8 shows that the one-piece arm 1 is tapered to mitigate a distinct natural frequency of the one-piece arm 1 and possibly resulting squeak and rattle issues. In other words, the one-piece arm 1 comprises a body which is narrowed along is longitudinal side from its second end 3 to its first end 2. Moreover, FIG. 8 shows a first and a second hole through the narrow side of the one-piece arm 1 at the first or upper end 2 and at the second or lower end 3 of the one-piece arm 1 respectively. The first and the second through holes in the one-piece arm 1 are part of the pivotal mounting of the first end 2 to the top bar 5 of the roller blind and of the second end 3 to a mounting part for linearly sliding the second end 3 of the one-piece arm 1.

FIG. 9 shows an embodiment of the two one-piece arms 1a, 1b for operating a roller blind in an example arrangement with respect to the motor 4 as part of a drive assembly for the roller blind. Thus, FIG. 9 indicates the simplified design and reduced part count of the embodiment of the window shade system 100 according to FIG. 2 with respect to the conventional window shade system according to FIG. 1. This simplified design and reduced part count create less opportunity for squeak and rattle issues during operation or generally while a corresponding vehicle is driven.

FIG. 10 shows an embodiment of a positive stop bumper 14 for a roller blind 20 to prevent rattle—in particular of the top bar 5 of the roller blind 20—in a stowed position of the roller blind 20. In this embodiment, the top bar 5 of the roller blind 20 comprises a rubber wheel 15 at each of its ends that sit on the stop bumpers 14 in the stowed position of the roller blind 20.

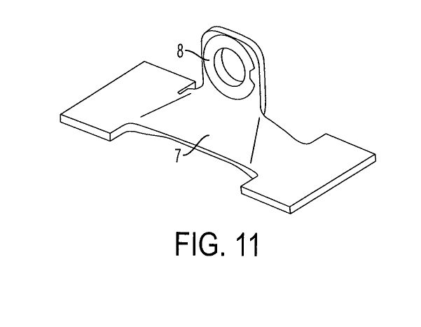

FIG. 11 shows an embodiment of a mounting part 7 with a polytetrafluoroethylene coated axle bushing 8 for pivotally connecting the second ends 3a, 3b of the one-piece arms 1a, 1b with the linearly sliding parts of the drive assembly for the roller blind 20 through a bottom pivot rivet. The polytetrafluoroethylene coated axle bushing 8 reduces the squeak and rattle potential at the pivoting interface between the rack and pinion drive and the second ends 3a, 3b of the one-piece arms 1a, 1b.

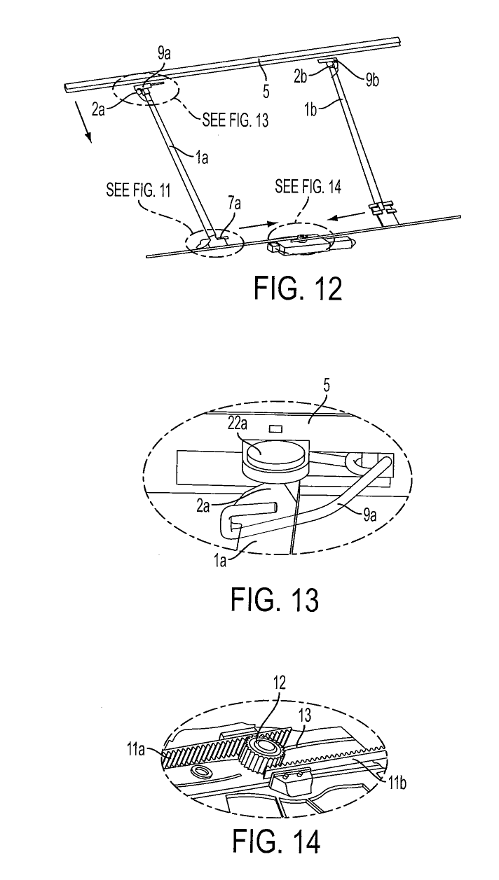

FIG. 12 shows an embodiment of the two one-piece arms 1a, 1b for operating the roller blind 20 in an example arrangement with respect to the top bar 5 of the roller blind 20 and the motor 4 as part of the drive assembly for the roller blind 20. FIG. 12 shows two upper spring assemblies 9a, 9b at the first ends 2a, 2b of the one-piece arms 1a, 1b to improve deployment consistency of the roller blind 20.

FIG. 13 is a magnified detail of FIG. 12 as indicated by the upper ellipse in FIG. 12 and shows an embodiment of an upper spring assembly 9a as biasing means coupled between the first or upper end 2a of the one-piece arm 1a pivotally connecting the one-piece arm 1a and the top bar 5 of the roller blind 20 by a pivot rivet 22a. The spring assembly 9a may maintain a constant opposing force on the one-piece arm 1a—which may also be referred to as linkage arm—and may thus aid in consistent deployment of the roller blind 20.

FIG. 14 is a magnified detail of FIG. 12 as indicated by the lower ellipse in FIG. 12 and shows an embodiment of a rack and pinion drive system. The racks 11a, 11b are driven by pinion 12 for linearly sliding the mounting parts 7a, 7b pivotally connected to the second ends 3a, 3b of the two one-piece arms 1a, 1b for operating the roller blind 20. FIG. 14 also shows that the mechanism comprises over-molded cables with guide shoes.

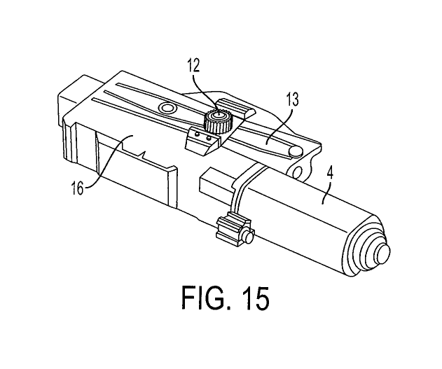

FIG. 15 shows an embodiment of a motor 4 mounted in-line to a track assembly 16 for the rack and pinion drive system of FIG. 14 as part of the drive assembly for the roller blind 20. The track assembly 16 may comprise an integrated wear plate 13 to further reduce the part count of the window shade system 100. The motor 4 may comprise a smaller package, in particular in respect to Z-height to reduce the installation space for the drive assembly.

Furthermore, the motor 4 may comprise an integrated electronic corrector. The noise of the motor 4 may be less than five sones with less than 15% pitch variation. The motor 4—such as an MD5 motor—may provide CPU flexibility by means of being flash capable. The design of the window shade system 100 may further be simplified by using a carry-over product from sunroof applications of the applicant as motor 4.

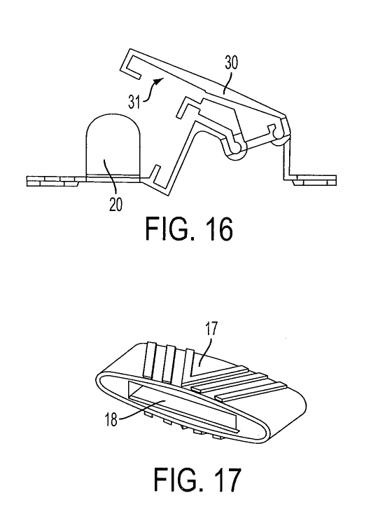

FIG. 16 shows an embodiment of a one-piece aluminum extruded track 30 providing a rigid body to mount the window shade system 100 of FIG. 2 to a vehicle package tray. The tapered surface 31 of the one-piece aluminum extruded track 30 avoids that the one-piece aluminum extruded track 30 achieves a distinct resonance frequency. Hence, the one-piece aluminum extruded track 30 may function as a carrier for the window shade system 100 and—inter alia—may address rattle issues of a frame to package tray sheet metal with respect to a low frequency (bass) range. Moreover, the mounting surface of the one-piece aluminum extruded track 30 is localized to fasteners.

FIG. 17 shows an embodiment of a two-piece guide shoe 17 with a rubber insert 18 for noise dampening as part of the drive assembly for the roller blind 20. The out guide show 17 may be manufactured from polyethylene to provide an anti-squeak functionality. The design of the window shade system 100 may further be simplified by using a carry-over product from other applications of the applicant as guide shoe 17.

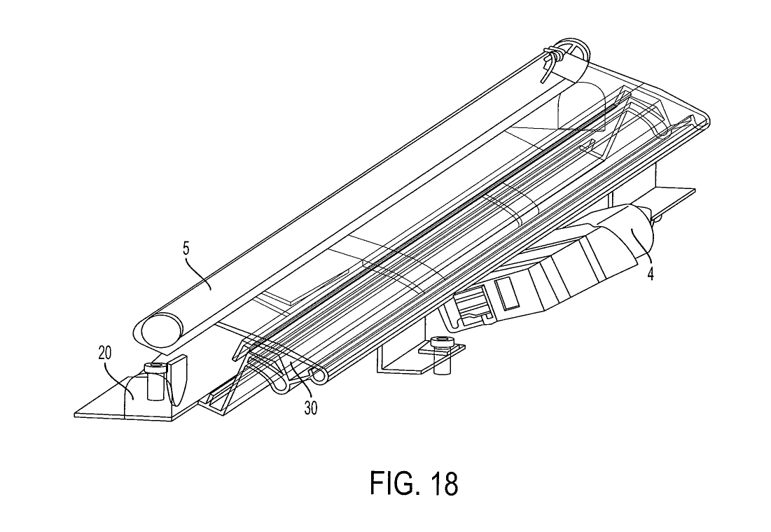

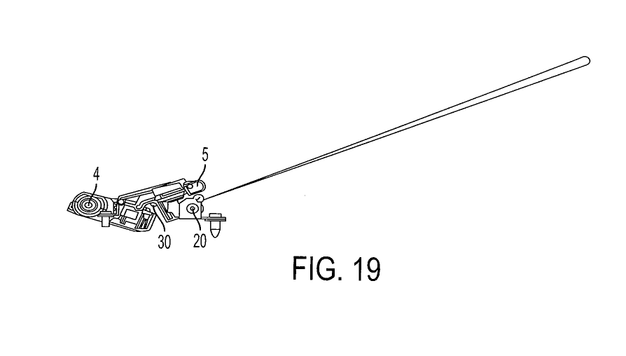

FIG. 18 shows an embodiment of the one-piece aluminum extruded track 30 protecting the roller blind 20 on three sides as a housing to provide robustness of the window shade system 100 to assembly handling. Moreover, the one-piece aluminum extruded track 30 provides ergonomic friendliness due to the one-piece design without a linkage. Furthermore, a retention feature for the window shade system 100 can be applied if needed. In addition, the pinion gear set up to push or pull cable provides further robustness to assembly handling since the mechanism may only deploy under power. Moreover, FIG. 18 shows that the motor 4 may be mounted to the one-piece aluminum extruded track 30. In this way, a defined alignment of the motor 4 with respect to the other parts of the drive assembly for the roller blind 20 may be achieved.

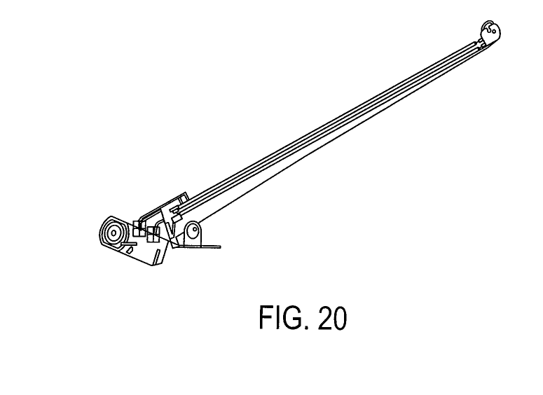

FIGS. 19 and 20 show side views of an embodiment of the window shade system 100 comprising means for exerting a contact force between the top bar 5 of the roller blind 20 and a rear window of a vehicle. In this way, bouncing movements of the top bar 5 of the roller blind 20 during a rough road drive may be avoided. The contact force may be fine tuned by performing bench level vibration testing. Moreover, FIG. 19 shows design tolerances surrounding the deployment angle of the window shade system 100 such as the angular tolerance of the fastening of the window shade system 100 on a package tray metal and the angular tolerance of the placement of the rear window.

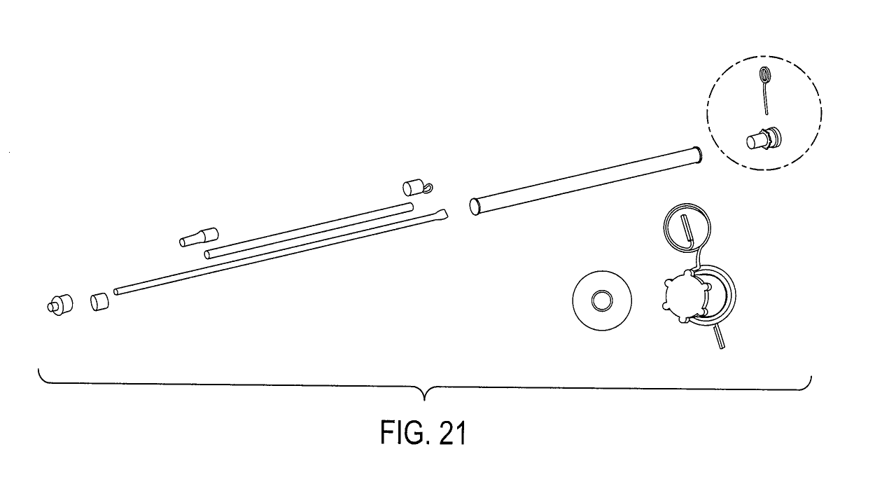

FIG. 21 shows an embodiment of inner and outer isolating sleeves on a spring of a roller blind system as part of the window shade system 100. In an embodiment, dampening grease may be applied to the spring. In this way, also the roller blind system may contribute to prevent squeak and rattle issues. The design of the window shade system 100 may further be simplified by using a carry-over product from other applications of the applicant as roller blind system.

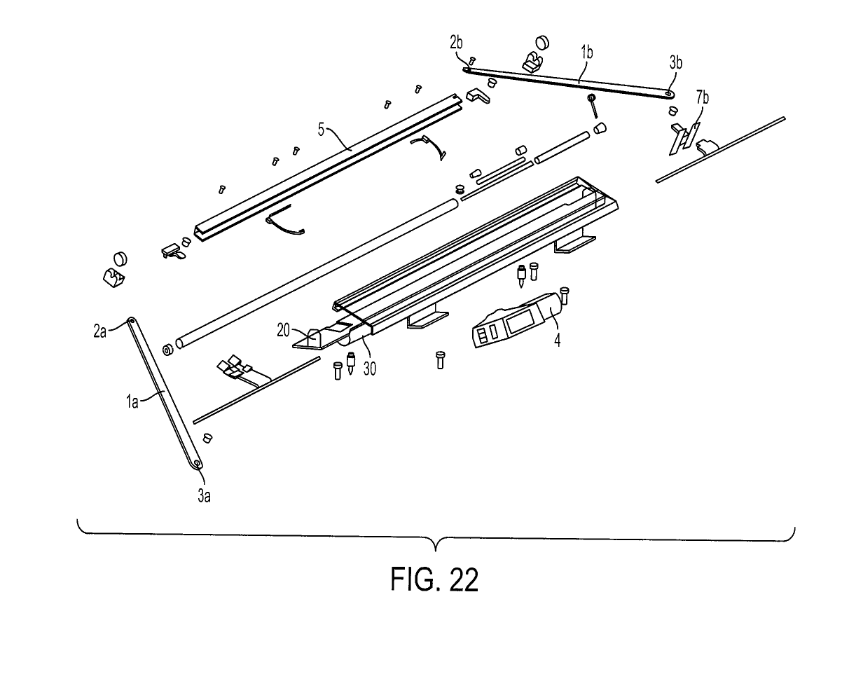

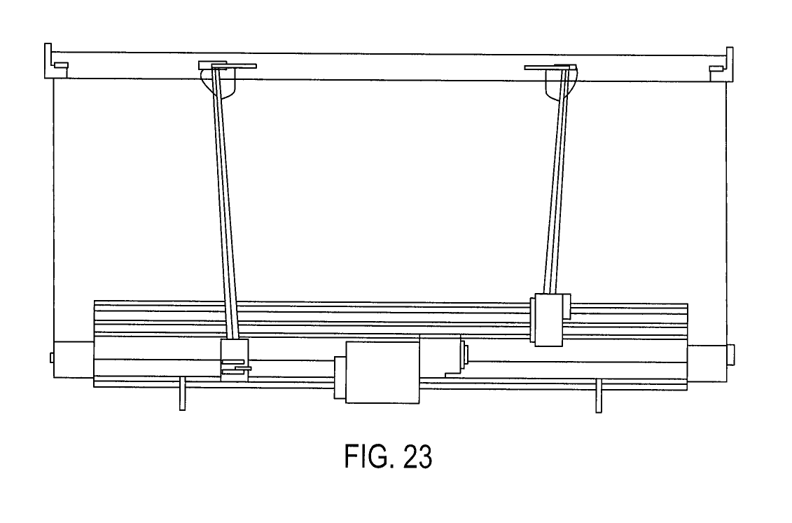

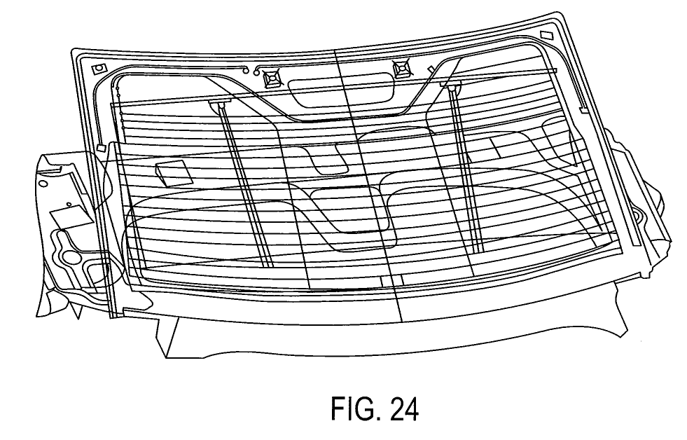

FIG. 22 shows an exploded view of the window shade system 100 according to FIG. 2 and demonstrates the relatively low part count of the window shade system 100. In an embodiment, the part count may be as low as 48 in comparison to 135 parts of an example of a conventional window shade system.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. Drive assembly for driving a window shade of a vehicle, in particular a roller blind for a rear window of a vehicle, comprising:
at least two one-piece arms, first ends of which are pivotally coupleable to a window shade, and
a driving means, in particular a motor, for linearly sliding pivotally mounted second ends of said one-piece arms arranged such that said one-piece arms may push or pull a window shade across a window of a vehicle.

2. The drive assembly of claim 1, wherein the one-piece arms are tapered and/or reinforced to mitigate a distinct natural frequency of said one-piece arms and possibly resulting squeak and rattle issues.

3. The drive assembly of claim 1, wherein the pivotal mounting of the second ends of said one-piece arms comprises a polytetrafluoroethylene coated bushing for receiving a pivot rivet.

4. The drive assembly of claim 1, wherein biasing means are coupleable between the first ends of said one-piece arms and a window shade to maintain a constant opposing force on each of said one-piece arms and enable a consistent deployment of a window shade.

5. The drive assembly of claim 1, wherein the driving means is mounted to a one-piece aluminum extruded track mountable to a vehicle package tray.

6. Window shade system for a vehicle, in particular for a rear window of a vehicle, comprising:
a drive assembly according to any of the preceding claims, and
a window shade, in particular a roller blind.

7. The window shade system of claim 6, comprising means for exerting a contact force between a top bar of said window shade and a window of a vehicle.

8. The window shade system of claim 5, wherein the window shade is mounted to the one-piece aluminum extruded track such that window shade is protected by the one-piece aluminum extruded track.

9. The window shade system of claim 6, wherein the window shade comprises a positive stop bumper to prevent rattle in a stowed position of the window shade.

10. Method for driving a window shade of a vehicle, in particular for a rear window of a vehicle, comprising:
pushing or pulling a window shade across a window of a vehicle by:
using at least two one-piece arms, first ends of which are pivotally coupleable to a window shade, and
linearly sliding pivotally mounted second ends of said one-piece arms by a driving means, in particular a motor.
